(19) United States
(12) Patent Application Publication
(10) Pub. No.: US 2015/0252660 A1
(43) Pub. Date: Sep. 10, 2015

(54) FIBER AGGLOMERATION SYSTEM AND METHOD

(71) Applicants: Zinaida Usova, Sugar Land, TX (US); Avinash Ramesh, Houston, TX (US); Mark Ayyad, Sugar Land, TX (US); Jeese Lee, Sugar Land, TX (US); Bruno Lecerf, Houston, TX (US); Laurent Coquilleau, Houston, TX (US); Kim Hodgson, Sugar Land, TX (US)

(72) Inventors: Zinaida Usova, Sugar Land, TX (US); Avinash Ramesh, Houston, TX (US); Mark Ayyad, Sugar Land, TX (US); Jeese Lee, Sugar Land, TX (US); Bruno Lecerf, Houston, TX (US); Laurent Coquilleau, Houston, TX (US); Kim Hodgson, Sugar Land, TX (US)

(21) Appl. No.: 14/440,367

(22) PCT Filed: Oct. 25, 2013
(86) PCT No.: PCT/US13/66797

§ 371 Date: May 4, 2015

(51) Int. Cl. E21B 43/26; E21B 36/00; C09K 8/62

(52) U.S. Cl. CPC E21B 43/26; C09K 8/62; E21B 36/00; C09K 2208/08

(57) ABSTRACT

A method is provided of adding material to an oilfield application in which a material is agglomerated into a compacted volume. The compacted volume is delivered into a processing system to produce a dispersed material. The dispersed material is used to perform the oilfield application.

### BACKGROUND

The following descriptions and examples are not admitted to be prior art by virtue of their inclusion in this section.

In order to facilitate the recovery of hydrocarbons from oil and gas wells, the subterranean formations surrounding such wells can be hydraulically fractured. Hydraulic fracturing may be used to create cracks in subsurface formations to allow oil or gas to move toward the well. A formation is fractured by introducing a specially engineered fluid (referred to as “fracturing fluid” or “fracturing slurry” herein) at high pressure and high flow rates into the formation through one or more wellbore. The fracturing fluids may be loaded with proppants, which are sized particles that may be mixed with the fracturing fluid to help provide an efficient conduit for production of hydrocarbons from the formation/reservoir to the wellbore. Proppant may comprise naturally occurring sand grains or gravel, man-made or specially engineered proppants, e.g. fibers, resin-coated sand, or high-strength ceramic materials, e.g. sintered bauxite. The proppant collects heterogeneously or homogenously inside the fracture to “prop” open the new cracks or pores in the formation. The proppant creates planes of permeable conduits through which production fluids can flow to the wellbore. The fracturing fluids are preferably of high viscosity, and therefore capable of carrying effective volumes of proppant material.

In order to prepare fracturing fluid, large quantities of solid material need to be safely processed, e.g., transportation, handling metering, and mixing for example. Different materials used for proppants come with different requirements for processing.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments of the claimed disclosure may comprise a method of adding material to an oilfield application comprising agglomerating the material into a compacted volume. The method may further comprise delivering the compacted volume into a processing system to produce a dispersed material. Additionally, the method may include performing the oilfield application with the dispersed material.

Other or alternative features will become apparent from the following description, from the drawings, and from the claims.

### BRIEF DESCRIPTION OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is a graph of the effect of heat treatment on crystallinity of polyvinyl alcohol (PVOH) according to an embodiment of the disclosure;

FIG. 2 is a graph of the relationship between solubility in water and the degree of hydrolysis of polyvinyl alcohol (PVOH) with a nominal degree of polymerization of 1750, according to an embodiment of this disclosure;

FIG. 3 is chart showing amorphous vs. hydrogen bond strength for G-Polymer™;

FIG. 4 is a graph showing the solubility of water of G-Polymer™, and

FIG. 5 is a photo showing briquettes of fibers according to an embodiment of this disclosure.

### DETAILED DESCRIPTION

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the disclosure.

Moreover, inventive aspects lie in less than all features of a single disclosed embodiment. Thus, the claims following the Detailed Description are hereby expressly incorporated into this Detailed Description, with each claim standing on its own as a separate embodiment.

Embodiments of this disclosure may relate to novel methods and systems of delivering solids, for example, at a wellsite. The various embodiments may be adapted to deliver solids that have shapes, sizes, aspect ratios, that make it difficult to handle and/or meter. One example of such a solid is a fiber fluid additive, referred to simply as a “fiber”.

In some cases, these methods and systems include the use of dry briquettes (e.g., bales, bricks, tablets, spheres, granules, pellets, among others) of various sizes and shapes which are bound to be dispersed in a fluid (often water based) used for the well treatments. A briquette may comprise fibers, other treatment chemicals and water soluble binders. As will be further described in the detailed section and examples, fibers with or without the added binder are compacted together with applied pressure so that once dried, the fibers substantially stay in a modified form.

In addition to numerous benefits, some of which include but are not limited to:
Automated feeding of fiber briquette through the silo, conveyer belt and other feeding devices.
Increased precision in dozing and metering of fibers.
Significant optimization of fiber related logistic: reduction of storage space, etc.
Manpower reduction.
Health, Safety, and Environment (HSE) footprint: the risk of airborne fibers being inhaled by the personnel on site is reduced.

One obvious HSE benefit is that the fibers briquettes can be delivered in larger quantities or by bulk methods, such as big bags or silos, and fed automatically into the treatment fluid, contrary to the current practice of using multiple quantities of relatively small fiber bags (e.g., 25-50 kg bags) and having to manually opening and feed the fiber. Dosing in briquette form may also improve the metering accuracy, and therefore improve the overall quality of treatment execution.

Readily dispersible fibers can be utilized extensively for oilfield applications such as fracturing, acidizing, cementing etc. Core techniques for the intensification of oil and gas recovery such as Schlumberger Technology Corporation's FiberFrac™, HIWAY™, StimMore™ and others are based on the usage of fibers as a frac fluid additive. For example, in some embodiments fibers may be dispersed in an aqueous hydraulic fracturing gel slurry and then pumped downhole. In this particular case fibers may serve as a proppant transport additive, to prevent premature settling of the proppant and further propagation of the proppant. In all oilfield applications, uniform distribution of fibers and accurate dosages are essential characteristics in facilitating success.

The fibers should be readily dispersible into the slurry so that the fibers are separated from one another and distributed evenly throughout the slurry. However, in many applications the fibers are required to be provided to a field location in a form that is easy to transport, handle in bulk, dispense and meter.

Generally, fibers can be quite bulky but they need to be transported from the manufacturing site of the fibers to remote field locations for final use, and in significant volumes. During transportion, it is important to design systems and methods so that the fiber properties are not affected in this process. These precautions will help to ensure the effectiveness of the fiber in an oilfield application.

Embodiments of the current disclosure suggest the use of solid briquettes for fiber delivery. Briquette can be of any form, shape and the material which is suitable to hold the composition, without allowing the release of the fiber agent from the briquette prior to contact of briquette with water or other dispersing agent.

Many of the parameters and the form of the briquette will depend on the type and amount of the fiber agents in the container, characteristics of the briquette and type and design of the oilfield application. In general, the characteristics required from a briquette are to be compact, to hold or maintain, to deliver or transport, and to release the fiber agents at a required stage or point in the process or application.

The timing of the briquette dispersion may be determined by factors such as the material of the binder used for briquette manufacturing, shape and size of the briquette, liquid media conditions such as media type, viscosity, temperature, amount of impurities, pH etc, as well as conditions such as agitation rate, etc. The briquette should be designed in a convenient form for fiber additive delivery and handling in the surface equipment, as opposed to downstream in the well. Additionally the briquette should be designed to disperse within the surface equipment and not designed to maintain its original shape and form as the fibers are pumped into the well.

Embodiments of the briquette may be dispersible, dissolvable, partially dissolvable, disintegrable, degradable or decomposed by one or combination of—hydrolysis, chemical trigger, temperature trigger, pH trigger or mechanic trigger. The embodiments of the briquettes can be of any form and shape, in some cases spherical or ellipsoid, but also in the form of tablets, cuboids, chips, bundles, sheets, among others. The briquettes can be rigid or semi-rigid, maintaining their general shape and withstanding moderate static and dynamic loads. Dispersion time may determined or influenced by the type and grade of the material used as a binder, the amount and concentration of the binder added, the media, pH, temperature, and amount of impurities, among other factors not expressly listed. In some embodiments, the briquettes can be covered or coated with multiple protective layers having various properties to ensure briquette integrity and prolong shelf life.

Some embodiments of fiber briquette may have following general properties:
outline dimension in a range of 1-1000 mm
density, in a range of 0.001-10 g/cc
tensile strength in a range of 0.001-200 MPa
elongation at break, %: 0.001-350%
dispersion time in a range of 1-10,000 sec

One significant component of the briquette is a solid or fiber material. In some embodiments, binding and/or wetting agents can also be added. Alternatively, or in addition, other chemicals such as for example glidants can be optionally premixed with the fibers and added into briquette. One option in some embodiments is to coat the fiber with an agent that ensures cohesion when the fibers are submitted into the process of making the briquette. The process of making briquettes may involve compression and may further include steps to activate such a cohesive fiber coating (e.g., by exposure to temperature for example). The briquettes can also be covered with one or more layers of the protective coating of a material similar to the binder composition, a different chemical composition, or a combination thereof.

Embodiments of solids, such as fibers, may be selected from a group including substituted and unsubstituted lactides, glycolides, oilylactice acid and polyglycolic acid, copolymers of glycolic acid with other hydroxy-, carboxylic acid-, or hydroxycarboxylic acid-containing moieties, and mixtures thereof, polyethylene, polyethylene terephthalate, cellulose, fibrous glass fibers, phenol formaldehyde fibers and others not expressly identified.

Embodiments of binders may include commercial products such as G-polymer™ of various grades commercially produced by Nippon Gohsei (for example, see http://www.g-polymer.com/eng/), polyvinyl alcohols (PVOH, PVA, or PVAI) with various degrees of crystallinity and of different grades, such for example those available from DuPont under the trade name Elavnol™ (for example, see http://origin.dupont.com/Elvanol/en_US/).

PVOH is a synthetic resin prepared by the polymerization of vinyl acetate, followed by partial hydrolysis of the ester in the presence of an alkaline catalyst. The principal grades of produced polyvinyl alcohol can be classified as fully hydrolyzed (having a range of approximately 97.5%-99.5% degree of hydrolysis) and partially hydrolyzed (having a range of approximately 87%-89% hydrolysis). PVOH is a commercially important water soluble plastic currently in use. Some characteristics of PVOH are that it is tasteless, odorless, it will biodegrade and is biocompatible. In addition to being soluble in water, PVOH is slightly soluble in ethanol, but insoluble in other organic solvents.

A general representation of an embodiment of PVOH can be described by the following scheme:

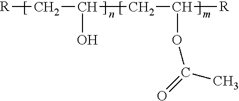

The scheme does not indicate the features of non-random acetate side-group distribution, and of the presence of side-chains, both of which are significant in relation to physical properties. The principal structural variations in the polymer are:
Chain length; chain length distribution
Degree of hydrolysis (degree of acetylation)

It is known that the nature of several, if not all, of the structural features of PVOH can be impacted by the methods and conditions of polymerization of the polyvinyl acetate from which the PVOH is prepared. It should be also realized that commercial PVOHs can be prepared to a particular “specification” by blending separate polymers of possibly different origins and properties. This process will tend to broaden the range of the chain length and branching distribution, and possible side-chain stereo regularity.

The effect of this considerable uncertainty is that it is difficult, if not impossible, to make detailed comparisons of the “secondary” properties of PVOHs of nominally similar specifications in terms of viscosities and degree of hydrolysis.

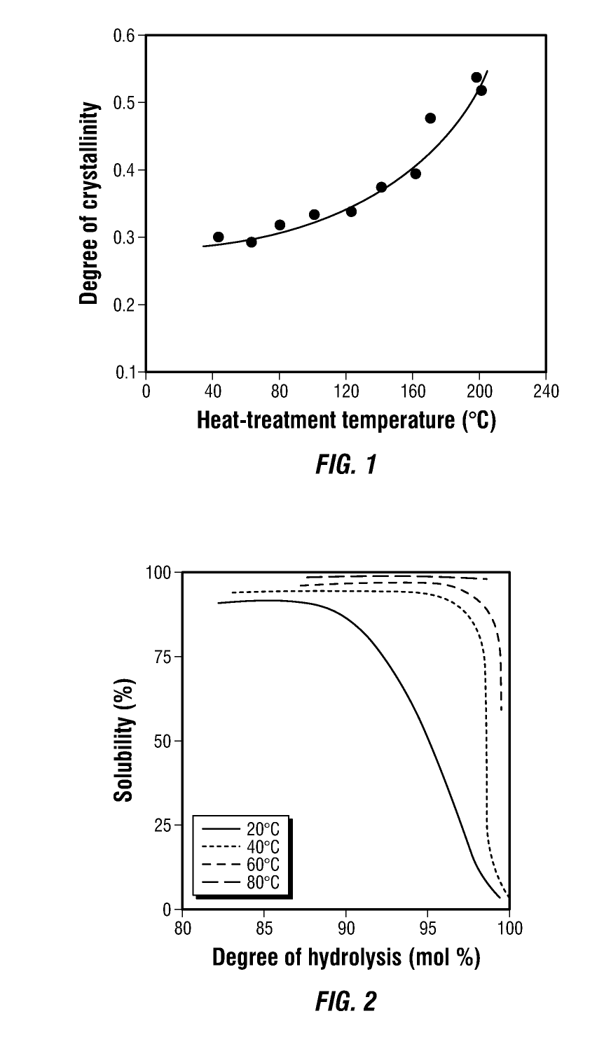

The solubility of PVOH films varies to a significant extent with the heat treatment during which the film is dried. Heat treatment causes the crystallinity of fully hydrolyzed polyvinyl alcohol to increase, as shown in FIG. 1, thereby reducing their solubility in water. In practice, films of fully hydrolyzed grades of PVOH do not lose their solubility if the heat treatment is kept below 100 deg C. Partially hydrolyzed grades (e.g., approximately 87%-89% hydrolysis), however, maintain almost the same water solubility (at 40 deg C.) unless they are subjected to a relatively severe treatment of 180 deg C. for 1 hour.

Solubility depends on the degree of crystallinity and on the structure of the amorphous regions. The nature of these regions are likely to depend on the randomness (or otherwise) of residual acetate groups, and of branching, of the polymer chain. Both properties are affected by the conditions of polymerization of polyvinyl acetate, and its subsequent hydrolysis as shown in FIG. 2. Accordingly, the solubility of PVOH in water depends in some part on the degree of hydrolysation and degree of polymerization, with the effect of the former being relatively more significant. Some PVOH grades with higher degrees of hydrolysation (>98%) are only soluble in hot water (e.g., in the range of 50-100 deg C.) and may form films that are insoluble in water at lower temperatures. In contrast PVOH grades with lower degrees of hydrolysation such as in the range of 75%-98% are easily soluble in water.

Molecular weight is another factor affecting the solubility of PVOH and the extent of the influence of molecular weight is related to the degree of hydrolysation. The solubility of highly hydrolyzed PVOH increases as the molecular weight decreases, while the solubility of less hydrolyzed PVOH is relatively independent of molecular weight.

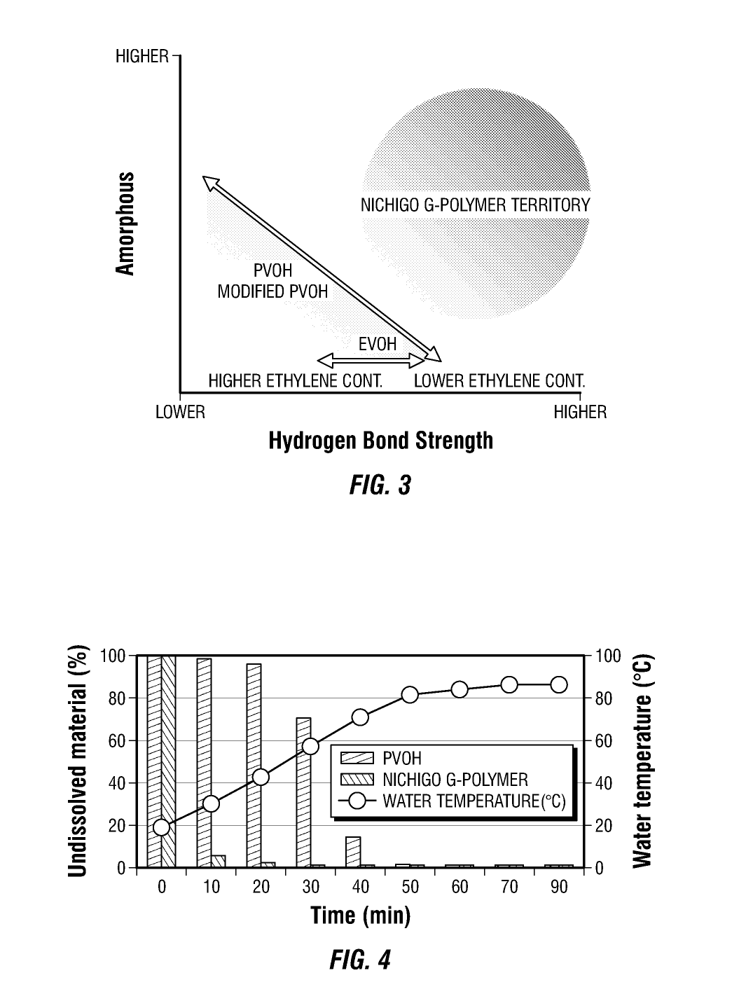

Nichigo G-polymer™ (Nippon Gohsei is a commercial producer of a vinyl alcohol copolymer) is a high amorphous content vinyl alcohol resin where crystallinity can be tailored to the point of having a totally amorphous character. Nichigo G-Polymer™ combines two typically opposing functions; although it may be an amorphous resin, it also has crystalline-like functions. Such combination functions are evidenced by the relatively good gas barrier properties and chemical resistance of Nichigo G-Polymer™ similar to PVOH (polyvinyl alcohol) and EVOH (ethylene vinyl alcohol copolymer) resins, along with water solubility and far lower crystallinity. Nichigo G-Polymert™ is water solubile even at low temperatures. The dissolution rate of Nichigo G-Polymert™ varies significantly according to the grade and can be regulated by controlling crystallinity. Some properties of Nichigo G-Polymert™ are shown in FIGS. 3 & 4.

Embodiments of the current disclosure may use a variety of other binding materials, including, but not limited to polysaccharides such as starch, chitosan, guar gum, hydroxyethyl guar, hydroxypropyl guar, hydroxybutyl guar, hydroxyethyl cellulose, carboxymethyl cellulose, carboxymethyl hydroxyethyl cellulose, xanthan gum carrageenan popcorn polymers, starch-polyvinyl alcohol copolymers, starch based polymers, various grades of methylcellylose polymer, polyacrylamide, polyvinylimidazole, polymethacrylic acid, polyvinylamine, polyvinylpyridine, polyethylene, various polyhydroxyalkanoates, polylactic acid and copolyesters, aliphatic-aromatic polyesters, Polyhydroxyalkanoates: poly[R-3-hydroxybutyrate], poly[R-3-hydroxybutyrate-co-3-hydroxyvalerate], poly[R-3-hydroxybutyrate-co-4-hydroxyvalerate], and various proteins such as gelatin, gluten etc.

Embodiments of the briquettes can be manufactured by one or combination of several of the known techniques including, but not limited to, molding, pressing, gluing, shrink wrapping, solvent composition, infrared, or UV, among others, in such way that final properties of fibers and other additives packed in briquette form are not affected.

In one example, 30 grams of Poly lactic acid fibers made of Nature Works™ PLA6202D with an average length of 5-7 mm are mixed with a 20 wt % water solution of G-polymer™ supplied by Nippon Gohsei, grade OKS-8049 and formed into cuboids. As a result the volume of fibers is decreased from 1700 ml to 100 ml. Once placed in water the cuboids are dispersed and fibers are re-fluffed within 90 seconds.

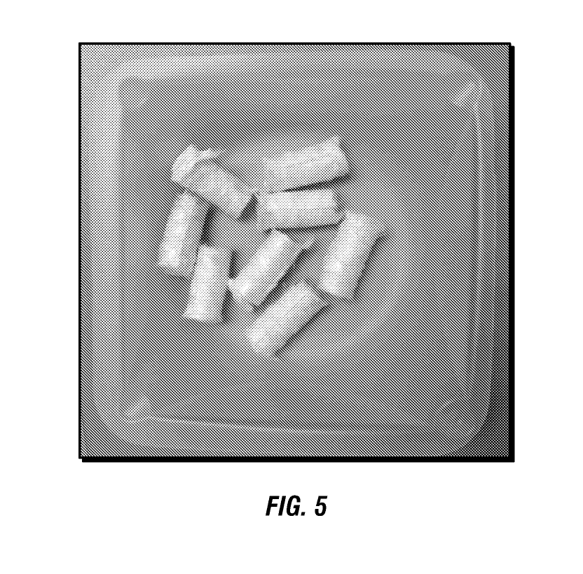

In another example, 12 grams of Poly lactic acid fibers made of Nature Works™ PLA6202D with average length 5-7 mm were mixed with 6 ml of 20% by weight of water solution of G-Polymert™ supplied by Nippon Gohsei, grade OKS-8049 and used to create 12 cylindrical pellets (⅓ in dia, ¾ in height) as shown below (see FIG. 5).

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method of adding material to an oilfield application comprising:
agglomerating the material into a compacted volume;
delivering the compacted volume into a processing system to produce a dispersed material; and
performing the oilfield application with the dispersed material.

2. The method of claim 1 wherein the material is a fiber.

3. The method of claim 1 wherein the oilfield application is hydraulic fracturing.

4. The method of claim 1 wherein the processing system further comprising mixing the compacted volume with a hydraulic fracturing fluid.

5. The method of claim 1 wherein the compacted volume is a briquette.

6. The method of claim 1 wherein a binder is added to the material prior to agglomerating the compacted volume.

7. The method of claim 6 wherein the binder is degradable.

8. The method of claim 6 wherein the binder is dissolvable.

9. The method of claim 6 wherein the binder disperses upon mixing with a hydraulic fracturing fluid.

10. The method of claim 6 wherein the binder disperses upon application of heat.

11. The method of claim 6 wherein the binder disperses upon addition of a dispersing agent.

12. A method for transporting fiber material to a well site comprising:
agglomerating the fiber material and a temporary binder into a briquette;
loading the briquettes into a storage container;
metering the briquettes from the storage container into a mixer;
mixing the briquettes with other components of a hydraulic fracturing fluid.

13. A method for hydraulically fracturing an underground formation comprising:
agglomerating a fiber material into a plurality of reduced volume forms;
transporting the reduced volume forms to a well site;
processing the reduced volume forms along with other components of a hydraulic fracturing fluid;
injecting the hydraulic fracturing fluid into the underground formation.

14. The method of claim 13 wherein the agglomerating the fiber material further comprises adding a temporary binder to the fiber material.

15. The method of claim 13 wherein the temporary binder is degraded and the fiber material dispersed when processing the reduced volume forms along with the other components of the hydraulic fracturing fluid.

16. The method of claim 13 wherein the reduced volume form is a briquette.

17. The method of claim 13 wherein processing the reduced volume forms further comprises:
adding the reduced volume forms to a storage silo;
metering the reduced volume forms to a mixer;
mixing the reduced volume forms with the other components of the hydraulic fracturing fluid.

18. The method of claim 17 wherein one of the other components of the hydraulic fracturing fluid is water.

19. The method of claim 17 wherein processing the reduced volume forms further includes:
heating the reduced volume forms to degrade the temporary binder; and
fluffing the fiber material to proximate pre-agglomerating levels.

20. The method of claim 13 wherein the fiber material is polyvinyl alcohol (PVOH).
